(19) United States
(12) Patent Application Publication
(10) Pub. No.: US 2023/0004719 A1
(43) Pub. Date: Jan. 5, 2023

(54) DIGITAL DATA PROCESSING SYSTEMS AND METHODS FOR MULTI-DOMAIN DIGITAL CONTENT RETRIEVAL AND GENERATION WITH DEAD-END PREVENTION

(71) Applicant: Earley Information Science, Inc., Carlilsle, MA (US)

(72) Inventors: Seth Earley, Carlisle, MA (US); Ashok Subramanian, Cambridge, MA (US); Prakash Govindarajulu, N. Billerica, MA (US); Jeannine Anne Bartlett, Hull, MA (US)

(21) Appl. No.: 17/364,741

(22) Filed: Jun. 30, 2021

(51) Int. Cl. G06F 40/30; G06F 9/451; H04L 12/58

(52) U.S. Cl. CPC G06F 40/30; G06F 9/451; H04L 51/02; G06Q 40/08

(57) ABSTRACT

A system for digital content that includes a content management system, an ontology manager and a chat bot, all executing and in communications coupling on a digital data processing system. The content manager stores a plurality of tagged digital assets. The ontology manager stores a list of (or otherwise maintains) plural facets, each corresponding to one or more tags—and at least one corresponding to two or more tags, e.g., of differing domains—of the content management system. One or more dialog segments and sequence identifiers are maintained in the ontology manager, as well, each associated with one or more other facets. The chat bot drives a conversation with an end-user based on facets identified as associated with assets in the content management system and using dialog segments associated with those facets, while excluding those facets not so identified. The digital data processing system generates and transmits to the user digital assets identified through that conversation and, when used in connection with commerce, may facilitate acquisition from inventory of items represented by those assets.

### BACKGROUND OF THE INVENTION

The invention pertains to digital data processing and, more particularly, to information retrieval and generation. It has application, by way of example, in assisting users in interacting with enterprise portals, e.g., in connection with commercial transactions.

We are an information society and, perhaps more importantly, an information economy. We generate information. We store it. And, we are willing to pay to curate it and to consume it. The big question, though, is how do we find it? Perhaps the biggest single ready source of information, the Internet, has led the drive in answering that question.

One of the early popular information retrieval systems was Yahoo! Directory, a hierarchical category-based tool—or “web directory”—for finding web sites. A user interested in finding information about health care insurance, for example, might click through a hierarchy of categories on the Yahoo! Directory portal, beginning with “business and economy” and proceeding through “business to business,” “financial services,” “insurance,” and ending with “health” to find a listing of health insurers' websites of potential interest.

Exponential growth of the Internet, both in terms of the number of websites and number of users, rendered browsing on Yahoo! Directory, and like sites, obsolete. Not only did it prove impossible for human editors to categorize the myriad of sites coming online daily, increasingly large numbers of users lacked the expertise and fortitude to navigate the ever-growing hierarchical category directories.

As a consequence, web “searching” (as opposed to “browsing”) has become the norm, through portals like Google, Bing, Baidu, and the like. Instead of requiring that users select among hierarchies of categories, the search engines locate individual web pages in response to user keyword and natural language requests. Some refer to this as the Ask-Tell model. Continuing the above example, the user interested in health care insurance can type that very term into a search portal and, with luck, will receive a listing of sites and pages of interest.

For those wishing information from a specific web site, say, of a health insurance provider, information retrieval has, to date, largely been through hierarchical category directories or, alternatively, through “Ask-Tell” searching hosted by the site owner and focused on content within that site. Just as with the Internet writ large, category browsing for specific information content on individual web sites has proven equally unworkable, except for all but those with a few, simple collections of content. Likewise, unless the content on a website is both focused and well architected, the Ask-Tell model is likely to return incomplete results, thereby, frustrating user requests.

As a consequence, chat bots (or “bots”) have emerged as a next-generation search engine of choice for at least site-specific searches. For enterprises, the chat bot is viewed as one of the more effective additions to marketing and sales channels to conveniently and efficiently carry out two-way conversations with customers, potential customers, and other end users. In simple terms, chat bots are automated software conversational “intelligent assistants,” typically, powered by machine learning which at its core is a simple way of achieving Artificial Intelligence (AI).

Ideally, chat bots powered by AI would learn and improve from real conversations with real end users. Reality has proven otherwise. Today's bots fail to understand the open-ended questions asked by the users and often do not know what to do next—no matter how much content the bots have been fed or random training they have been given.

In view of the foregoing, an object of the invention is to provide improved methods and systems for digital data processing.

A related object of the invention is to provide such improved methods and systems as can be adapted to improving communications with end users both for purposes of general communications and for purposes of site- or portal-specific communications, e.g., whether for marketing and sales of product offerings or other enterprise assets of value to customers.

A related object of the invention is to provide such methods and systems as are capable of constructing more contextually-aware intelligent assistants.

Another object is to provide such methods and systems as are suited for information retrieval.

A related object of the invention is to provide such methods and systems as are adept at discerning contextually-aware user intent.

Still another object is to provide such methods and systems as can be used to assist users in the retrieval of information from enterprise portals and other information sources.

A related object of the invention is to provide such methods and systems as can be used to assist users in the retrieval of a mix of disparate content, cataloged data and other digital assets that make up the more complete response to a user inquiry.

### SUMMARY OF THE INVENTION

The foregoing are among the objects attained by the invention, which provides in some aspects a system for digital content retrieval and generation that includes one or more content management systems, an ontology manager and a chat bot, all executing and in communications coupling on a digital data processing system. Each content manager stores (or otherwise comprises), for each of a plurality of digital assets, an identifier of the respective digital asset and one or more associated tags (e.g., keywords or phrases) that characterize that asset and which tags may be, for example, selected from among one or more knowledge domains. The digital assets, themselves, may be maintained in stores local to the content management system or otherwise (e.g., remotely addressable by it).

The ontology manager stores a list of (or otherwise maintains) plural content facets, each corresponding to one or more required tags of the content management system, and at least one of the content facets corresponds to two or more such tags that can be, according to some aspects of the invention, from differing respective knowledge domains (or, simply, “domains”). The content facets, too, may be keywords or phrases and, indeed, each facet may be identical to the tag to which it corresponds, though, it need not be. One or more dialog segments (e.g., queries or portions of conversations) are stored or otherwise maintained in dialog facets by the ontology manager, and each such dialog facet is associated with one or more content facets. The ontology manager also keeps indicators, e.g., set and maintained through synchronization with the content management system, of facets whose corresponding tags are associated with digital assets in the content management system. Collectively, these lists, facets, indicators, (and, where applicable) domains, etc. are used to guide the chat bot system and user interaction through an ontology-specified dialog.

The chat bot drives a conversation with a user through a human machine interface (e.g., a special- or general-purpose software application such as a browser, a voice-activated device, or otherwise) using dialog segments that are expanded with content facets associated with the dialog facets in which those segments are included. The chat bot includes in the expansions only those content facets for which all corresponding required tags are associated with assets in the content management system and excludes from expansion those content facets those that are not. The digital data processing system generates and transmits to the user digital assets identified through that conversation.

Further aspects of the invention provide a system for digital content retrieval and generation, e.g., as described above, in which the content management system and the ontology manager exchange facets and/or tags for synchronization, i.e., to establish correspondence between facets of the ontology manager and tags available for characterizing digital assets and/or potential digital assets in the content management system. During the sync, the content management system and ontology manager can also exchange information to identify tags (and, thereby, corresponding facets) that are associated with digital assets in the content management system.

Still further aspects of the invention provide a system for digital content retrieval and generation, e.g., as described above, in which the chat bot identifies tags associated with facets designated by the user during the conversation. And, in related aspects, the invention provides such a system in which the content management system retrieves digital assets associated with those tags, and the browser or other human machine interface transmits those digital assets to the user.

Other aspects of the invention provide a system for digital content retrieval and generation, e.g., as described above, in which the ontology manager stores (or otherwise comprises) sequence numbers associated with the plural facets. The chat bot, according to these aspects of the invention, drives the conversation sequentially as an additional function of those sequence numbers.

Yet still further aspects of the invention provide a system for digital content retrieval and generation, e.g., as described above, in which the ontology manager stores (or otherwise comprises) one or more lexical indicators, each identifying one or more facets belonging to a common language, dialect or other lexicon, and in which the chat bot drives the conversation as an additional function of the lexical indicator associated with content and/or dialog facets, including those associated with a designated lexical indicator and excluding those which are not.

In other aspects, the invention provides a system for digital content retrieval and generation, e.g., as described above, in which the chat bot drives conversations with any of text, radio boxes, check boxes and other user interface widgets. Format indicators that are associated with the facets and upon which the chat bot makes formatting selections are provided in the ontology.

Still further aspects of the invention provide a system for digital content retrieval and generation, e.g., as described above, in which the ontology comprises a hierarchy of facets including one or more main facets and, associated with each of at least one of them, plural other facets descendant in the hierarchy on that main facet and corresponding to one or more tags of the content management system, a sequence number and one or more dialog segments.

In related aspects of the invention, where a like facet is descendant from two different main facets in the ontology's hierarchy, the chat bot—which normally drives the conversation based on sequence numbers—disregards those numbers when driving the portion of the conversation involving that like facet.

Other aspects of the invention provide a system for digital content retrieval and generation, e.g., as described above, in which the chat bot drives the conversation as a stateless dialog with the user.

In related aspects of the invention, the chat bot searches the ontology hierarchy to identify a facet matching a user response during the conversation in order to determine how to further drive the conversation.

The foregoing and other aspects of the invention are evident in the discussion that follows, as well as in the drawings and the claims.

### BRIEF DESCRIPTION OF THE DRAWINGS

A more complete understanding of the invention may be attained by reference to the drawings, in which

FIG. 1 depicts a system and method for digital content retrieval and generation according to one practice of the invention.

### DETAILED DESCRIPTION OF THE ILLUSTRATED EMBODIMENT

### Architecture

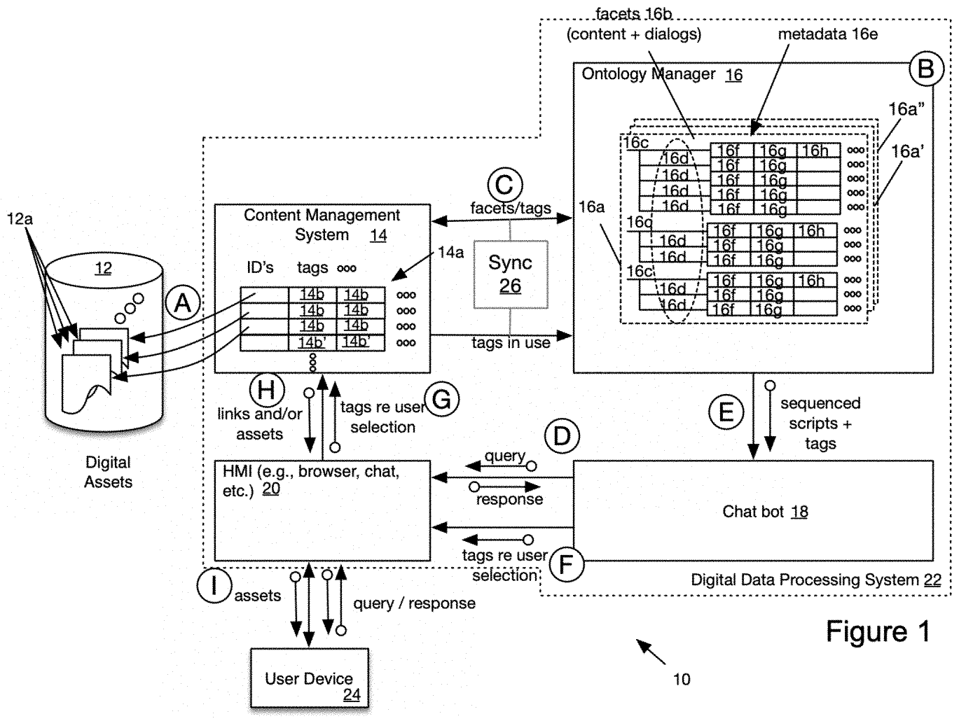

FIG. 1 depicts a system 10 for digital content retrieval and generation according to one practice of the invention. The illustrated system 10 includes a digital asset store 12 that is coupled with a content management system (CMS) 14. An ontology manager 16 is coupled with the CMS 14, as well as with a chat bot 18. Human machine interface 20 is coupled to the chat bot 18, as well as to the CMS 14. Illustrated elements 14-20 execute on digital data processing system 22, which in the illustrated embodiment comprises a mainframe computer, minicomputer, workstation, desktop computer, portable computer, or handheld device or other digital data processing device of the type known in the art, as adapted in accord with the teachings hereof. In other embodiments, those elements 14-20 may be implemented in distributed fashion or otherwise as per convention in the art, as adapted in accord with the teachings hereof, on a collection of two or more such digital data processing devices coupled for communication, e.g., over a local area network (LAN), wide area network (WAN), metropolitan area network (MAN), public network (Internet), or otherwise, in the conventional manner known in the art, as adapted in accord with the teachings hereof.

Digital asset store 12 comprises a conventional digital asset management (DAM) system or digital asset collection of the type known in the art capable of storing, managing and/or accessing electronic documents (such as, by way of nonlimiting example, PDFs, word processing documents, spreadsheets, images, videos, music and/or other digital works, all of the conventional type known in the art, as adapted in accord with the teachings hereof). In some embodiments, those digital assets may be sellable items in an inventory. Examples of such sellable digital assets can be, by way of non-limiting example, a research paper, movie, music or Computer-Aided Design (CAD) rendering available for purchase. Alternatively, or in addition, the digital assets may, themselves, represent physical or other assets—for example, as where the digital asset store 12 is used in connection with retail, warehouse or other inventory control and where items in the asset store 12 reflect actual items in such an inventory. An example of such a digital asset can be, by way of non-limiting example, a web page describing a product in inventory and including a user-interface widget to facilitate purchase of the product. Moreover, those digital assets may represent services, for example, in instances where the digital asset store 12 is maintained by or on behalf of an accounting firm, a plumbing company, and so forth, whose “inventory” comprises days, half-days, hours or other units of service, and where a digital asset represents such units of service (again, for example, a web page with a widget to facilitate scheduling the service). Regardless of their nature and/or what they represent in any particular embodiment, the digital assets in store 12 are referred to as “physical or other” assets (or items) in the discussion that follows.

The asset store 12 may be independent of digital data processing system 22, as shown in the drawing, yet coupled to it for communications via LAN, WAN, MAN, Internet, or otherwise, in the conventional manner known in the art, as adapted in accord with the teachings hereof. In other embodiments, the asset store 12 forms part of system 22 itself, e.g., as in the case of a document or other digital asset store contained on the “disk drive” local to system 22, again, in the conventional manner known in the art as adapted in accord with the teachings hereof. In yet other embodiments, the asset store 12 forms part of the content management system 14, in the conventional manner known in the art as adapted in accord with the teachings hereof.

User device 24 comprises a conventional digital data device of the type known in the art for end user access to digital data processing system 22. This may be a dumb- or smart-terminal that is directly or indirectly coupled to the system 22 per convention, as adapted in accord with the teachings hereof, or a digital data processing system in its own right, e.g., a mainframe computer, minicomputer, workstation, desktop computer, portable computer, handheld device, or other digital data processing device that is coupled for communications with system 22 via a LAN, WAN, MAN, Internet or otherwise, all per convention in the art as adapted in accord with the teachings hereof.

### Content Management System (CMS) 14

CMS 14 comprises a conventional content management system of the type known in the art as adapted in accord with the teachings hereof that manages access to—and, more typically, as well, the storage of—digital assets of one or more of the types identified above (i.e., electronic documents, images, text content, structured or semi-structured product data, etc.). CMS 14 can, as well, manage the creation and modification of such digital assets. CMS 14 of the illustrated embodiment comprises Adobe Experience Manager, although other CMSs of the type known in the art, whether commercially available in the marketplace or otherwise, may be used instead or in addition—all, as adapted in accord with the teachings hereof.

Although only a single content management system 14 is shown in the drawing and discussed below, it will be appreciated that multiple such systems (e.g., each constructed and operated as described herein vis-à-vis CMS 14) can be utilized instead (e.g., each for a respective type of digital asset and/or for content from a respective domain, e.g., of the type discussed below) as is within the ken of those skilled in the art in view of the teachings hereof.

In embodiments in which digital assets in store 12 represent physical or other assets, e.g., in a retail, warehouse or other inventory, the content management system may form part of or include an inventory control or product information management (PIM) system that organizes and updates the digital asset store 12 to accurately reflect the quantity and type (e.g., via SKU or otherwise) of each item contained in, added to and/or removed from the retail, warehouse or other inventory. The integration of such inventory control and/or product catalog capabilities with the CMS 14 is within the ken of those skilled in the art in view of the teachings hereof.

Relevant for purposes hereof, CMS 14 of the illustrated embodiment maintains records 14a (whether in a list, array, database or other data structure (consolidated, distributed or otherwise), each of which associates a respective digital asset 12a—which may, itself, be identified in the record by a pointer (such as a local or global URL) or other identifier—with one or more tags 14b characterizing the digital asset (i.e., describing its properties), e.g., in format, content, language or otherwise, all per convention in the art as adapted in accord with the teachings hereof. See FIG. 1, step (A).

In embodiments in which digital assets in store 12 represent physical or other assets, e.g., in a retail, warehouse or other inventory, one or more of the tags 14b may characterize attributes of those physical or other assets, instead and/or in addition. In the discussion that follows, a tag (or tags) 14b may be referred to as “characterizing,” “associated with” or being “for” a digital asset 12, regardless of whether the tag characterizes a digital asset 12 itself and/or a physical or other asset represented by that digital asset.

Tags 14b, which can comprise identifiers, categories, concepts, keywords or phrases, can be organized within the CMS 14 hierarchically or otherwise, again, as per convention as adapted in accord with the teachings hereof. By way of illustrative, non-limiting example, tags for digital assets pertaining to insurance might include, as main nodes or properties, the categories, AUDIENCE, CONTENT TYPE, HEALTH PLAN, OBJECTIVE and PROVIDER. Children of the AUDIENCE property might include, by way of further illustrative, non-limiting example, the tags BROKER, EMPLOYER, GOVERNMENT AGENCY, and PROFESSIONAL ORGANIZATION, whereas those of the HEALTH PLAN main node might include, by way of further illustrative, non-limiting example, the tags ACO, HMO and PPO.

By way of further non-limiting example, tags for digital assets maintained in a store 12 by a beef wholesaler might reflect not only characteristics of its current inventory of goods, but also of recipes or other publications on their preparation. Thus, for example, tags 14b pertaining to the wholesaler's inventory might include, as main nodes or properties, terms or categories from a first knowledge domain (hereinafter, “domain”), to wit, cuts of beef, e.g., CHUCK PRIMAL, RIB PRIMAL, LOIN PRIMAL, PLATE PRIMAL, FLANK PRIMAL, and ROUND PRIMAL. Children of the ROUND PRIMAL category might include, by way of example, the tags STEAMSHIP ROUND, BOTTOM ROUND, EYE OF ROUND, SIRLOIN TIP, and TOP (INSIDE) ROUND, whereas those of the PLATE PRIMAL category might include, by way of further example, the tags HANGER STEAK, INSIDE SKIRT STEAK, OUTSIDE SKIRT STEAK AND PLATE SHORT RIBS. And, by way of still further example, tags 14b might include terms or categories from a second domain, to wit, cooking methods and recipes, such as ON A STOVETOP, IN THE OVEN and OUTDOOR GRILLING. Children of the ON A STOVETOP category may include, by way of example, the tags PAN-BROILING IN A SKILLET, BRAISING IN A POT, and STIR-FRYING, whereas those for the OUTDOOR GRILLING category may include, by way of example, the tags GRILLING ON A BARBEQUE, INDIRECT GRILLING and ROTISSERIE GRILLING. Of course, systems according to the invention are not limited to use of tags from only one or two domains: tags 14b from still other domains may be utilized as well.

Tags 14b in CMS 14 are created, managed and associated with digital assets via records 14a in the conventional manner of the art, as adapted in accord with the teachings hereof. Thus, for example, while such tags may be created in the CMS and placed in such records 14a in the first instance via an administrator or other operator directly or via a batch process, they may as well be created through invocation of an API, graphical user interface (GUI) or otherwise, e.g., as in the case of tags created by the synchronization module 26, as discussed below.

One such GUI, by way of illustrative, non-limiting example, permits an end user-operator to select, from among drop-down widgets associated with each of the main nodes/categories (e.g., AUDIENCE, CONTENT TYPE, HEALTH PLAN, OBJECTIVE, in the example, above) specific child tags (e.g., BROKER, EMPLOYER, GOVERNMENT AGENCY, and PROFESSIONAL ORGANIZATION for the AUDIENCE category, in the example above).

In addition to tags 14b that are associated with digital assets currently in store 12, the CMS 14 can store in records 14a or otherwise, tags 14b′ available for use in characterizing potential digital assets 12a. In the case of embodiments in which digital assets in store 12 represent physical or other assets, e.g., in a retail, warehouse or other inventory, tags 14b′ can be ones available for use in characterizing on-order goods and/or out-of-stock goods, by way of non-limiting example.

### Ontology Manager 16

Ontology manager 16 is a conventional ontology manager of the type known in the art (as adapted in accord with the teachings hereof) that creates and manages an ontology 16a, that is, a list of hierarchy and/or knowledge graph categories, concepts, keywords or phrases (collectively, “facets” 16b) that, like tags, characterize actual or potential digital assets in store 12 (and CMS 14). As above, those characteristics (or attributes) may pertain to format, content, language or otherwise, by way of illustrative, non-limiting example. Ontology manager 16 of the illustrated embodiment comprises Wordmap® of Earley Information Science, the assignee hereof, although other ontology managers of the type known in the art, whether commercially available in the marketplace or otherwise, may be used instead or in addition—all, as adapted in accord with the teachings hereof.

Although only a single ontology 16a is shown in the drawing and discussed below, it will be appreciated that multiple such ontologies (e.g., each constructed and utilized as described herein vis-a-vis ontology 16a) can be utilized instead (e.g., each for an ontology of a respective domain of the type discussed above) as is within the ken of those skilled in the art in view of the teachings hereof. Thus, for example, continuing the example above, one ontology 16a can be provided for terms pertaining to cuts of beef, and another ontology (shown in FIG. 1 as element 16a′, but discussed below with common reference to element 16a for sake of simplicity) can be provided for methods of cooking and recipes, all by way of non-limiting example. Ontology 16a of the illustrated embodiment is organized hierarchically, as shown in the drawing, with main facets 16c that correspond to main nodes of the tags discussed above, and sub-facets (or children)—also known as “categories,” “terms” or “concepts”—16d that descend hierarchically from respective main facets and that correspond to child nodes or tags in the discussion above.

In the illustrated embodiment, facets corresponding to tags in the CMS share the same name (or identifier) as the corresponding tag—which corresponding tag is occasionally referred to herein as a “required tag” or “corresponding required tag.” Thus, continuing the insurance example above, ontology 16a may include, as main facets 16c, the terms AUDIENCE, CONTENT TYPE, HEALTH PLAN, OBJECTIVE, and PROVIDER; children or sub-facets 16d of the main facet AUDIENCE may include the sub-facets 16d BROKER, EMPLOYER, GOVERNMENT AGENCY, and PROFESSIONAL ORGANIZATION; and so forth, all in parallel to correspondingly named tags of CMS 14 and all by way of illustrative, non-limiting example. Likewise, continuing the beef wholesaler example above, ontology 16a may include, as main facets 16c, the terms CHUCK PRIMAL, RIB PRIMAL, LOIN PRIMAL, PLATE PRIMAL, FLANK PRIMAL, ROUND PRIMAL, ON A STOVETOP, IN THE OVEN, and OUTDOOR GRILLING; children or sub-facets 16d of the main facet ROUND PRIMAL category might include, by way of example, the facets STEAMSHIP ROUND, BOTTOM ROUND, EYE OF ROUND, SIRLOIN TIP, and TOP (INSIDE) ROUND; and so forth, again, in parallel to the correspondingly named tags of CMS 14 and all by way of non-limiting example.

Other embodiments may utilize facets 16b that, although corresponding to required tags of the CMS 14, do not match them in name as in the example above. In those embodiments, metadata associated with the facets can be used to identify their corresponding tags, as discussed below.

A more complete listing of an exemplary ontology for use with digital assets pertaining to insurance is reprinted below, with bracketed expressions indicating whether the facets are main facets 16c or sub-facets 16d:
Audience [16c]
   Broker [16d]
   Employer [16d]
   Government Agency [16d]
   Professional organization [16d]
Content type [16c]
   Articles [16d]
   Brochures [16d]
   Contracts [16d]
   Testimonials [16d]
Health plan [16c]
   ACO [16d]
   HMO [16d]
   PRO [16d]
Objective [16c]
   Assess [16d]
   Educate [16d]
   Influence [16d]
   Inform [16d]
Provider [16c]
   Assisted living [16d]
   Behavioral health [16d]
   Community-based care [16d]
   Urgent care [16d]

Likewise, an exemplary ontology 16a for use with digital assets representing inventory and recipes of a beef wholesaler in accord with the example above might include the following main facets 16c and sub-facets 16d:
Chuck Primal [16c]
   Chuck Tender [16d]
   Chuck Roll [16d]
   Shoulder Clod [16d]
   Square-Cut Chuck [16d]
Rib Primal [16c]
   Ribeye Roll [16d]
   Rib Subprimal [16d]
      Ribeye Steak [16d]
      Prime Rib Roast [16d]
Loin Primal [16c]
   Tenderloin [16d]
   Strip Loin [16d]
   Short Loin [16d]
Plate Primal [16c]
   Hanger Steak [16d]
   Inside Skirt Steak [16d]
   Outside Skirt Steak [16d]
   Plate Short Ribs [16d]
Round Primal [16c]
   Steamship Round [16d]
   Bottom Round [16d]
   Eye Of Round [16d]
   Sirloin Tip [16d]
   Top (Inside) Round [16d]
On A Stovetop [16c]
   Pan-Broiling In A Skillet [16d]
   Braising In A Pot [16d]
   Stir-Frying [16d]
   Pressure Cooking [16d]
In The Oven [16c]
   Roasting Or Baking [16d]
   Broiling [16d]
   Skillet To Oven [16d]
Outdoor Grilling [16c]
   Grilling On A Barbecue [16d]
   Indirect Grilling [16d]
   Rotisserie Grilling [16d]

In some embodiments, “content” facets 16b (e.g., those corresponding to tags in the CMS 14) can correspond with more than one required tag—as is particularly useful in embodiments where terms or categories from multiple domains are employed by the CMS 14.

Such may the case, for example, of cooking recipe-related sub-facets 16d in an ontology 16a for use with digital assets pertaining to beef wholesale, continuing the example above. Thus, in addition to corresponding to specific tags from a cooking method/recipe ontology in the CMS 14, recipe-related sub-facets 16d can correspond to required tags from a beef cut ontology to reflect the type of meat or other ingredients required in those recipes. For example, a sub-facet 16d named Ginger-Maple Steak corresponding to a required tag GINGER-MAPLE STEAK that characterizes digital assets 12a detailing such a recipe, may also correspond with the required tag STRIP STEAK reflecting the specific cut of meat required for the recipe. Correspondence of a facet 16b with such an additional required tag can be reflected in metadata of the facet, as discussed elsewhere herein.

Metadata associated with the content facets can also identify corresponding tags that are optional (or not “required”). For simplicity, in the text that follows (and elsewhere herein) a tag that is referred to as “corresponding” with a content facet can be assumed to be a “required” tag—i.e., one which must be in use in the CMS 14 for that content facet to form part of a script expansion—unless otherwise evident from context.

The ontology 16a is not limited to facets 16b that correspond to tags of the CMS 14: the ontology 16a may include other facets, as well. By way of non-limiting example, it may include sub-facets 16d that serve as scripts to direct conversations with end users to discern interests contemplated by the other facets of the ontology 16a. In the illustrated embodiments, those scripts are written in a markup-like language, though, other embodiments may vary in this regard, all as is within the ken of those skilled in the art in view of the teachings hereof.

Such a script, or “dialog facet” 16d as referred to below, may be, by way of illustrative, non-limiting example, of the form WHAT IS THE OBJECTIVE? IS IT TO <FACET_CHILDREN> or LET'S FOCUS ON YOUR PREFERRED GRILLING METHOD. WOULD YOU LIKE TO TRY <FACET_CHILDREN>? When used to generate a conversation with an end user, the dialog facet is “expanded”—i.e., the portion of its text in angle brackets is replaced by the siblings 16d of that dialog facet in the ontology 16a hierarchy—and, more specifically, by the sub-facets 16d that descend from the same main facet 16c as does the dialog facet.

Thus, for example, when applied with respect to the main facet OBJECTIVE and its sub-facets ASSESS, EDUCATE, INFLUENCE, and INFORM, the script WHAT IS THE OBJECTIVE? IS IT TO <FACET_CHILDREN> can be used to generate the outbound bot message (or “query”) to determine user intent “What is the objective? Is it to assess, educate, influence or inform?” Or, conversely, when applied with respect to the main facet OUTDOOR GRILLING and its sub-facets GRILLING ON A BARBEQUE, INDIRECT GRILLING and ROTISSERIE GRILLING, the script LET'S FOCUS ON YOUR PREFERRED GRILLING METHOD. WOULD YOU LIKE TO TRY <FACET_CHILDREN>? can be used to generate the outbound bot message/query “Let's focus on your preferred grilling method. Would you like to try grilling on a barbeque, indirect grilling or rotisserie grilling?”

Continuing the example above, combining dialog facets of the type described above with those characterizing digital assets pertaining to insurance provides the following ontology 16a. Again, as above, bracketed expressions indicate whether the facets are main facets 16c or sub-facets 16d:
Audience [16c]
   Broker [16d]
   Employer [16d]
   Government Agency [16d]
   Professional organization [16d]
[Dialog] What audience is this for? We have materials for <FACET_CHILDREN> [16d]
Content type [16c]
   Articles [16d]
   Brochures [16d]
   Contracts [16d]
   Testimonials [16d]
[Dialog] Hi there. I am the healthcare insurance sales chat bot. I can help you with <FACET_CHILDREN>. What kind of Content would you like? [16d]
Health plan [16c]
   ACO [16d]
   HMO [16d]
   PRO [16d]
[Dialog] Terrific. Is this for a specific plan? I can locate <FACET_CHILDREN> [16d]
Objective [16c]
   Assess [16d]
   Educate [16d]
   Influence [16d]
   Inform [16d]
[Dialog] What is the objective? Is it to <FACET_CHILDREN>[16d]
Provider [16c]
   Assisted living [16d]
   Behavioral health [16d]
   Community-based care [16d]
   Urgent care [16d]

Instead of including dialog facets in the ontology 16a as peers of the sibling sub-facets 16d with which they will be expanded (implicit context), the dialog facets may be consolidated under their own main facet 16c, e.g., DIALOGS, with dialog facts referenced by other domain ontologies (explicit context). Although discussed below for sake of simplicity as if it were included in ontology 16a, that main facet and, more generally, the dialog facets are, in some embodiments, maintained in their own ontology 16a′.

Regardless of whether maintained in the same or a separate ontology, and by way of non-limiting, illustrative example, such additional branch of an ontology dialog facets for use with digital assets pertaining to insurance is reprinted below:
Dialogs [16c]
   Hi there. I am the healthcare insurance sales chat bot. I can help you with <FACET_CHILDREN>. What kind of Content would you like? [16d]
   Terrific. Is this for a specific plan? I can locate <FACET_CHILDREN> [16d]
   What audience is this for? We have materials for <FACET_CHILDREN> [16d]
   What is the objective? Is it to <FACE_CHILDREN> [16d]

Another exemplary such additional branch of an ontology of dialog facets for use with digital assets pertaining to beef wholesale is reprinted below:
Dialogs [16c]
   OK, will you be cooking <FACET_CHILDREN>? [16d]
   Let's focus on your preferred Stovetop cooking method. Would you like to try <FACET_CHILDREN>? [16d]
   Let's focus on your preferred cooking method for the Oven. Would you like to try <FACET_CHILDREN>? [16d]
   Let's focus on your preferred cooking method for the Stovetop. Would you like to try <FACET_CHILDREN>? [16d]
   Let's focus on your preferred Grilling method. Would you like to try <FACET_CHILDREN>? [16d]

Thus, rather than residing in the ontology as siblings of the sub-facets with which they will be expanded, the dialog facets are siblings of one another. In these embodiments, explicit context associations between the dialog facets and the sub-facets 16d with which they will be expanded can be provided by globally unique identifiers (GUIDs), pointers or other cross-referencing data structures (whether maintained as part of metadata 16e or otherwise) and techniques within the ken of those skilled in the art in view of the teachings hereof.

In the discussion that follows, the term “sibling” is used to refer to sub-facets 16d with which a dialog facet will be expanded—regardless of whether the dialog facet is maintained in the ontology 16a as a peer of those sub-facets or whether the dialog facet is maintained in a separate branch of the ontology 16a along with other dialog facets.

In sum, in some embodiments, each main facet 16c of the hierarchy of ontology 16a has (i) plural sub-facets or children 16d that descend from it and that characterize aspects of actual assets in the CMS 14 (and store 12) or a potential such asset, as well as (ii) a dialog segment that is associated with those children and that can be used to drive a dialog with the end user in regard to those children. The dialog segment can, itself, be a sub-facet 16d in the ontology 16a and a sibling of those which it uses to drive those conversations. See FIG. 1, step (B). In other embodiments, the dialog segments are stored in a separate branch of the ontology 16a and associated, by way of pointers, GUIDs or otherwise, with the content facets and, more specifically, the “content” sub-facets 16d, with which they will be expanded in order to drive the end-user dialog, as discussed below.

Although some facets 16b of the ontology 16a correspond to tags in the CMS 14, some (e.g., dialog facets) do not. Moreover, in some embodiments, facets 16b in the former category may match their tags identically. Such is the case in the non-limiting, illustrative example below of facets 16b of ontology 16a and corresponding tags 14b of records 14a in CMS 14:

| Ontology 16a | | Tags 14b of CMS |
|---|---|---|
| Audience [16c] | <----> | Audience |
| Broker [16d] | <----> | Broker |
| Employer [16d] | <----> | Employer |
| Government Agency [16d] | <----> | Government Agency |
| Professional | <----> | Professional |
| organization [16d] | | organization |
| [Dialog] What audience | | |
| is this for? We have | | |
| materials for | | |
| <FACET.CHILDPEN> | | |
| [16d] | | |
| Content type [16c] | <----> | Content type |
| Articles [16d] | <----> | Articles |
| Brochures [16d] | <----> | Brochures |
| Contracts [16d] | <----> | Contracts |
| Testimonials [16d] | <----> | Testimonials |
| [Dialog] Hi there. I am | | |
| the healthcare | | |
| insurance sales chat | | |
| bot I can help you with | | |
| <FACET_CHILDREN>. | | |
| What kind of Content | | |
| would you like? [16d] | | |
| Health plan [16c] | <----> | Health plan |
| ACO [16d] | <----> | ACO |
| HMO [16d] | <----> | HMO |
| PRO [16d] | <----> | PRO |
| [Dialog] Terrific. Is this | | |
| for a specific plan? I | | |
| can locate | | |
| <FACET_CHILDREN> | | |
| [16d] | | |
| Objective [16c] | <----> | Objective |
| Assess [16d] | <----> | Assess |
| Educate [16d] | <----> | Educate |
| Influence [16d] | <----> | Influence |
| Inform [16d] | <----> | Inform |
| [Dialog] What is the | | |
| objective? Is it to | | |
| <FACET_CHILDREN> | | |
| [16d] | | |
| Provider [16c] | <----> | Provider |
| Assisted living [16d] | <----> | Assisted living |
| Behavioral health [16d] | <----> | Behavioral health |
| Community-based care [16d] | <----> | Community-based care |
| Urgent care [16d | <----> | Urgent care |

In the table above, correspondence between facets 16b of ontology 16a and corresponding tags 14b is reflected by the symbol “<---->”. In practice, correspondence is reflected by metadata associated with the facets 16b, as discussed below, and particularly, for example, by pointers, URLs, or globally unique IDs (GUIDs) contained in that metadata. Of course, in implementations where the facets and their corresponding tags have identical values, such pointers are not necessary—since, the fact of correspondence can be determined by comparison.

Facets 16b of the ontology 16a that correspond to tags in the CMS 14 are referred to as “content” facets. Content facets additionally include 16b facets in the hierarchy of ontology 16a that are direct ancestors (e.g., parents, grandparents, great-grandparents, great-great-grandparents, etc.) of a facet 16b that corresponds to a tag in the CMS 14. Thus, for example, in the excerpt of an ontology 16a shown in the table below, the facets RIBEYE ROLL, RIBEYE STEAK and PRIME RIB ROAST correspond with the tags, RIBEYE ROLL, RIBEYE STEAK AND PRIME RIB ROAST, respectively, and thus are content facets. The facets RIB PRIMAL and RIB SUBPRIMAL are content facets too, even though they do not directly correspond with tags, since both are parents and/or grandparents of facets that correspond with such tags.

| Ontology 16a | | Tags 14b of CMS |
|---|---|---|
| . | | . |
| . | | . |
| . | | . |
| Rib Primal [16c] | | |
| Ribeye Roll [16d] | <----> | RIBEYE ROLL |
| Rib Subprimal [16d] | | |
| Ribeye Steak | <----> | RIBEYE STEAK |
| Prime Rib Roast | <----> | PRIME RIB ROAST |
| . | | . |
| . | | . |
| . | | . |

Facets 16b of the ontology 16a of the illustrated embodiment are associated with metadata 16e, as shown in FIG. 1. For main facets 16c and sub-facets 16d, that metadata 16e includes (a) an identifier 16f of the tag in CMS 14 to which the main or sub-facet 16c, 16d corresponds, and (b) and indicator 16g of whether that tag is, indeed, “in use” in the CMS 14—that is, whether it has been applied to a digital asset currently accessible by the CMS 14—e.g., as opposed to tags which may be applied to potential assets but that are not applied to any such asset accessible by the CMS 14. See FIG. 1, step (B). In the case of a facet 16b that corresponds with two or more tags, multiple pairs of metadata fields 16f/16g may be populated, each for a respective one of those tags.

For main facets 16c (and, optionally, for sub-facets 16d), that metadata 16e can additionally include a sequence number 16h indicating the order in which the dialog segment(s) for that main facet (and, more particularly, for its sub-facets 16d) should be applied in conducting a conversation with an end-user. Thus, continuing the example above, to cause the conversation to begin with an outbound message (or query) to the end user regarding the audience that sought-after content is intended for, the AUDIENCE main facet 16c could be assigned a meta-data sequence number #1; and, to cause the conversation to turn, next, to the type of content, the CONTENT TYPE main facet 16c could be assigned a meta-data sequence number #2; all, by way of non-limiting example.

Ontology 16a, including its facets 16b and metadata 16e, can be stored in lists, arrays, databases or other data structures (consolidated, distributed or otherwise) of the type known in the art, as adapted in accord with the teachings hereof. The creation, maintenance and accessing of such an ontology, regardless of how stored, is within the ken of those skilled in the art in view of the teachings hereof.

Implementation of an ontology manager 16 for creation and management of an ontology 16a as described above and elsewhere herein is within the ken of those skilled in the art in view of the teachings hereof. Thus, for example, the facets 16b may be created in the ontology manager 16 in the first instance via an administrator or other operator directly or via a batch process. Once they are created in the ontology manager 16, facets 16b may be associated with corresponding tags of the CMS 14 through a batch interface, a graphical user interface (GUI) or otherwise that permits an administrator or other operator to assign tags, individually or in groups, to the facets to which they correspond, again, individually or in groups, as is within the ken of those skilled in the art in view of the teachings hereof. Alternatively, or in addition, the facets 16b may be created in the first instance and/or placed into association with corresponding tags of the CMS by synchronization module 26.

### Synchronization Module 26

Synchronization module (Sync) 26 exchanges facets and/or tags with the CMS 14 and ontology manager 16 to establish correspondence between tags of the former and facets of the latter, and to identify facets that correspond to tags associated with digital assets in the content management system. See FIG. 1, step (C). The module 26 can exclude facets from the synchronization process. In the illustrated embodiment, such excluded assets include dialog facets.

The module 26, which executes on digital data processing system 22, may form part of the CMS 14 and/or the ontology manager 16; alternatively, it may comprise a separate module, as shown in the drawing. Communications between the module 26 and the CMS 14 and/or manager 16 may be via APIs, remote procedure calls and/or other computer-to-computer and/or process-to-process communication protocols as per convention in the art as adapted in accord with the teachings hereof.

In operation, the synchronization module 26 queries the CMS 14 to identify tags 14b employed in records 14a identifying digital assets 12a in store 12. It also identifies those tags 14b′ that, although known to the CMS 14, are not currently so employed, i.e., tags 14b′ for potential such assets (which, as noted above, in the case of embodiments in which digital assets in store 12 represent physical or other assets, e.g., in a retail, warehouse or other inventory, can be ones on-order goods and/or out-of-stock goods, by way of non-limiting example). Likewise, the sync module 26 queries the ontology manager to identify facets 16b in the ontology 16a, as well as metadata 16e for those assets.

By comparing the tags and facets (and/or their respective metadata 16e), the sync module 26 can identify tags and/or facets that correspond with one another (e.g., by comparing the tag and facet names in embodiments that employ a like naming convention, by checking the values of metadata fields 16f or otherwise) and, upon making such identification, can test and set the metadata field 16g of the respective facet to properly reflect whether the respective tag is in use (i.e., whether it is associated with a record 14a that is associated with a digital asset 12a in store 12) or whether that tag is merely maintained in the CMS 14 for potential use in characterizing such an asset. This can be done for each tag to which a facet corresponds, whether reflected by like facet and tag names, whether reflected in metadata fields, or otherwise. In the case of a facet 16b that corresponds with two tags, for example, this may—depending on the content of the store 12—result in setting of the metadata for that facet to reflect that one of those tags in in use, but that the other is not.

Upon identifying tags that do not have corresponding facets, or vice versa, the synchronization module 26 can, depending upon implementation specifics, effect creation of missing tags or facets in the CMS 14 or ontology manager 16, as the case may be and/or can alert an operator of system 22 to do so.

Synchronization module 26 of the illustrated embodiment effects the foregoing, i.e., “synching” of the CMS 14 and the ontology manager 16 upon operator request or automatically, e.g., periodically (hourly, daily, etc.) or episodically (e.g., whenever changes are made to the CMS records 14a and/or ontology 16a), depending on implementation requirements. Implementation of the synchronization module 26 to effect the foregoing is within the ken of those skilled in the art in view of the teachings hereof.

### Chat Bot 18

Chat bot 18 is a conventional such software application for driving a conversation with an end user via general- or special-purpose human machine interface 20 (such as a web browser, chat app or otherwise) and via the user's device 24, all per convention in the art as adapted in accord with the teachings hereof. Chat bot 18 of the illustrated embodiment utilizes Aspect Conversational Experience Platform (CxP), Google Dialog Flow or other conventional chat bot framework(s) of the type known in the art, whether commercially available or otherwise, all as adapted in accord with the teachings hereof. Of course, it will be appreciated that, although, the term “chat” is associated with element 18, the conversational technique need not be via text. It can be spoken (e.g., as where the HMI includes a text to voice feature), multi-media (e.g., as where the HMI includes graphical avatars), or otherwise, as per convention in the art as adapted in accord with the teachings hereof.

To that end, the chat bot drives conversations with the end user (via HMI 20 and device 24) utilizing scripts contained in dialog facets, as expanded using content sub-facets 16d as discussed above. See FIG. 1, step (D). Thus, for example, reiterating the example above, in an ontology 16a for generating digital content vis-à-vis digital assets pertaining to insurance, a dialog facet that contains the script WHAT IS THE OBJECTIVE? IS IT TO <FACET_CHILDREN>? and that is a sibling of the sub-facets ASSESS, EDUCATE, INFLUENCE, and INFORM can be expanded to drive an outbound bot message (query) to the end user (via HMI 20 and device 24) WHAT IS THE OBJECTIVE? IS IT TO ASSESS, EDUCATE, INFLUENCE or INFORM? via a variety of conversational techniques as part of a dialog to identify digital assets 12 in CMS 14 of potential interest to the user. And, by way of further example, in an ontology 16a for use with digital assets pertaining to beef wholesaling, a dialog facet that contains the script LET'S FOCUS ON YOUR PREFERRED GRILLING METHOD. WOULD YOU LIKE TO TRY <FACET_CHILDREN>? and that is a sibling of the sub-facets GRILLING ON A BARBEQUE, INDIRECT GRILLING and ROTISSERIE GRILLING can be expanded to drive an outbound message (query) to the end user “Let's focus on your preferred grilling method. Would you like to try grilling on a barbeque, indirect grilling or rotisserie grilling?”

To avoid dead-ends in the conversation—that is, presenting options to the end user which, if selected, would not result in retrieval of digital assets 12a from the store 12—scripts are only expanded to include sibling facets 16d (i) all of whose corresponding (i.e., required) tags 14b are “in use” (i.e., correspond to digital assets 12a accessible via the CMS 14) or (ii) that are direct ancestors (i.e., parents, grandparents, great-grandparents, great-great-grandparents, etc.) of one or more facets all of whose corresponding tags are all in use.

Thus, continuing the examples above, in an ontology 16a for generating digital content vis-à-vis digital assets pertaining to insurance, a dialog facet that contains the script WHAT IS THE OBJECTIVE? IS IT TO <FACET_CHILDREN>? and that is a sibling of the sub-facets ASSESS, EDUCATE, INFLUENCE, and INFORM will expand to include only the facets ASSESS and INFLUENCE, by way of illustrative example, if only they (and not facets EDUCATE and INFORM) correspond to tags 14b that are in use, resulting in an outbound message (query) to the end user as follows: “What is the objective? is it to assess or influence?” Taking this to the extreme, if none of the facets ASSESS, EDUCATE, INFLUENCE, and INFORM correspond to in-use tags 14b, the chat bot will not present any variant of the script WHAT IS THE OBJECTIVE? IS IT TO <FACET_CHILDREN>?

Likewise, in an ontology 16a for generating digital content vis-à-vis assets pertaining to beef wholesale, a dialog facet that contains the script WHAT OUTDOOR GRILLING RECIPE WOULD YOU LIKE TO SEE? <FACET_CHILDREN>? and that is a sibling of the sub-facets GINGER-MAPLE STEAK, TANGY AVOCADO BURGERS, and HAWAIIAN SLIDERS, each of which correspond to both a recipe-related tag 14b and a sellable ingredient-related tag, will expand to include only the facets TANGY AVOCADO BURGERS and HAWAIIAN SLIDERS, by way of illustrative example, if only they (and not facet GINGER-MAPLE STEAK) correspond to both recipe-related and ingredient-related tags that are in-use in the CMS 14. This is true even if the facet GINGER-MAPLE STEAK corresponds to a recipe-related tag that is in-use, but not an ingredient-related tag that is in-use, thereby avoiding the risk of presenting a recipe selection option to the end user during the conversation for which a necessary ingredient is not available for purchase.

The aforesaid operations may be by action of the ontology manager 16 and/or the chat bot 18, as is within the ken of those skilled in the art in view of the teachings hereof.

In some embodiments, the ontology's metadata additionally includes lexical indicators, identifying a language, dialect or other lexicon with which each main facet 16c or sub-facet is associated. In such embodiments, localization of conversations driven by the chat bot 18 is achieved by retrieving and expanding only scripts associated with a given lexical indicator or indicators.

By way of example, in an embodiment in which some facets 16b have meta-data identifying the respective facets as English-language and other facets have meta-data identifying the respective facts as French-language, only those scripts associated with the French-language metadata lexical indicator are retrieved and expanded (and, then, only with siblings associated with that same lexical indicator) in driving conversation with users in France or French-speaking countries. In another embodiment, user responses and thus, intent, can also be matched to a lexicon of synonyms or thesaurus identifiers associated with the respective facets. By way of example, a beef domain ontology might include “Flap Meat” as a colloquial synonym for “Hanger Steak.” Further, user responses received by chat bot 18 may be expanded, translated or otherwise normalized through Natural Language Processing (NLP) techniques such as stemming or lemmatization to enhance the likelihood of more accurate matching to facet 16b keywords, phrases or lexicon terms, with NLP processing performed by chat bot 16 or ontology manager 16; use of such NLP processing techniques are readily apparent per convention in the art as adapted in accord with the teachings hereof.

Referring to step (E) of FIG. 1, chat bot 18 can retrieve scripts from the ontology manager 16 via API, remote procedure call or otherwise, as per convention in the art as adapted in accord with the teachings hereof. In the illustrated embodiment, chat bot 18 retrieves, along with scripts, tags corresponding to the sub-facets 16d with which those scripts are expanded. As well, in embodiments in which the ontology's metadata additionally includes format indicators, identifying a format (e.g., text, radio box, check box or other user-interface widget) with which conversations are to be driven, those format indicators are retrieved, along with scripts and tags.

Expansion of those scripts using siblings of the sub-facets 16d in which the scripts are contained (and using the user-interface widget specified in a format indicator, if any, retrieved with the script) can be performed by the ontology manager 16, the chat bot 18, or otherwise, all as is within the ken of those skilled in the art in view of the teachings hereof. Whether by action of the ontology manager 16 and/or the chat bot 18, scripts are retrieved to drive the conversation in an order determined by the sequence indicator contained in the metadata field 16h of the main facet 16c with which that dialog facet and those sub-facets are associated.

Thus, continuing the example above, in an ontology 16a in which one main facet 16c, e.g., the main facet AUDIENCE, is assigned a metadata sequence number of #1 and another main facet 16c, e.g., the main facet CONTENT TYPE, is assigned a metadata sequence number of #2, the chat bot 18 can drive the conversation with an outbound message (query) generated from expansion of the dialog facet associated with main facet AUDIENCE and, once that message is responded to by the user (via HMI 20 and device 24), with a subsequent outbound message (query) generated from expansion of the dialog facet associated with the main facet CONTENT TYPE. The chat bot can drive successive messages and queries in the conversation with expanded scripts generated from the other branches (i.e., main facets and related sub-facets) of the hierarchy associated with successively increasing sequence numbers.

In the illustrated embodiment, with each user response to a message (query) generated as discussed above, the HMI returns to the chat bot 18 his/her response for matching to one or more sub-facets as designated by the user through interaction with the expanded script that made up that dialog exchange. The chat bot 18 of the illustrated embodiment saves away (e.g., in a store local to the chat bot, in cookies in the user device 24 browser or otherwise) the tag(s) associated with that/those designated sub-facets. The chat bot 18 can also save away, along with those tags, a fulsome representation of the queries posed during the confirmation and the user's responses. This facilitates implementation of the conversation in a stateless manner such that a late-received response from a given user can be matched against the record of prior responses, e.g., in cookies in that user's device 24 browser or otherwise, to pick up the conversation where it had left off. Alternatively, a facet returned in such a late-received response can be matched against the ontology 16a hierarchy to identify the sequence number of the main facet and sub-facets associated with the script in connection with which the response was made and, thereby, to drive the conversation with the script associated with the next sequence number.

And, although, the chat bot 18 normally drives the conversation by generating outbound messages (queries) in accord with the sequence numbers associated with scripts and their main and sub-facets, the chat bot can deviate from that sequence in instances where a given term or expression is a sub-facet of two different main facets. In such an instance, a response by the user selecting that facet, when presented with it in connection with expansion of a script associated with one of those main facets, can cause the chat bot 18 to drive the conversation with the script associated with the next sequence number from that of the other main facet.

Regardless, once the conversation has been completed, e.g., via querying the user with all of the scripts implicated by the ontology 16a in the order specified therewith, the chat bot 18 passes the saved-away compilation of tags designated in the user responses to the HMI 20. See FIG. 1, step (F).

The HMI 20, in turn, applies those tags to CMS 14 to retrieve assets characterized by those tags or links thereto, all per convention in the art as adapted in accord with the teachings hereof. See FIG. 1, steps (G) and (H). The HMI can, in turn, generate as digital content for the user the assets returned in step (H). See FIG. 1, step (I). As a consequence, the HMI 20 and, more generally, the system 22 generates and returns to the user digital content meeting his/her responses to the outbound messages (queries) generated by the chat bot 18 based on the scripts contained therein.

And, because of dead-end avoidance as discussed above, there is no risk that a user selection during the conversation will result in a null return (that is, in no content being returned to him/her in step (I)) or, in instances like those discussed above, in which a user selection will result in a return that is other than fulsome—e.g., the return of a PDF or webpage containing a recipe selected by the user but no webpage or other asset via which the user may purchase an essential ingredient.

In embodiments where store 12 includes digital assets representing physical or other assets (for example, as where the digital asset store 12 is used in connection with retail, warehouse or other inventory control and where items in the asset store 12 reflect actual items in such an inventory) and/or where the CMS 14 is integrated with an inventory control system, e.g., as discussed above, the generation of digital content can include offering the user an opportunity to purchase goods from inventory. Thus, for example, a result of querying a user as described above vis-à-vis digital assets maintained by a beef wholesaler, can be the following digital content: (a) one or more PDFs (or images or web pages) with recipes for cooking strip steak, (b) a banner advertising a sale on packages of strip steak currently in inventory and including a “buy now” button facilitating the user's purchase of same.

Implementation of the chat bot 18, HMI 20 and CMS 14 to effect the foregoing is within the ken of those skilled in the art in view of the teachings hereof.

Described herein are systems and methods achieving the objects set forth above for generating dialog scripts and digital content based on retrieved assets. It will be appreciated that the embodiments described here are merely examples of the invention and that other embodiments, incorporating changes to those shown and described here fall within the scope of the invention, of which we claim the following.

In view of the foregoing, what we claim is:

1. A system for digital content retrieval and generation, comprising
A. a digital data processing system,
B. one or more content management systems executing on the digital data processing system, each content management system comprising, for each of a plurality of digital assets, (i) an identifier of the respective digital asset and (ii) one or more associated tags that characterize that asset,
C. an ontology manager executing on the digital data processing system in communications coupling with the content management system, the ontology manager representing one or more ontologies of different respective knowledge domains, each such representation comprising (i) plural content facets, each such content facet corresponding to one or more required tags of the content management system, where at least one of the content facets corresponds to two or more of required tags, and (ii) one or more dialog facets, each associated with one or more content facets, and each including a dialog segment expandable using those associated content facets, and (iii) an identification of content facets whose corresponding required tags are associated with digital assets in the content management system,
D. a chat bot executing on the digital data processing system in communications coupling with the ontology manager, the chat bot driving a conversation with a user through a human machine interface using dialog segments from said ontology as expanded with content facets associated with the dialog facets in which those segments are included, which content facets are also from the ontology manager, the chat bot expanding the dialog segments to include only content facets for which the corresponding required tags are identified as associated with assets in the content management system, while excluding those content facets not so identified,
E. the digital data processing system transmitting to the user digital assets identified through said conversation.

2. The system of claim 1, wherein the content management system and the ontology manager exchange facets and/or tags via the digital data processing system in order to (i) establish correspondence between content facets in the ontology manager and tags available for characterizing digital assets and/or potential digital assets in the content management system, (ii) identify facets that correspond to tags associated with digital assets in the content management system.

3. The system of claim 1, wherein the chat bot identifies tags corresponding with facets selected by the user during the conversation.

4. The system of claim 3, wherein the content management system retrieves digital assets associated with the tags identified by the chat bot.

5. The system of claim 4, wherein the human machine interface transmits to the user the digital assets associated with the tags identified by the chat bot.

6. The system of claim 1, wherein the ontology manager associates sequence numbers with the plural dialog facets, and wherein the chat bot additionally drives the conversation flow as a function those dialog sequence.

7. The system of claim 1, wherein the ontology comprises one or more lexical indicators, each identifying one or more facets belonging to a common language, dialect, synonyms or other lexicon, and wherein the chat bot drives the conversation as an additional function of the lexical indicator and lexicon values associated with facets.

8. The system of claim 7, wherein the chat bot drives the conversation to exclude dialog segments associated with facets not associated with one or more designated lexical indicators.

9. The system of claim 1, wherein the chat bot drives the conversation with any of text, radio boxes, check boxes and other user interface widgets.

10. The system of claim 9, wherein the ontology comprises one or more format indicators, and wherein the chat bot selects user interface widgets with which to drive the conversation as a function of those format indicators.

11. A method of digital content generation comprising executing on a digital data processing system, the steps of:
A. for each of a plurality of digital assets, maintaining on the digital data processing system (i) an identifier of the respective digital asset and (ii) one or more associated tags that characterize that asset,
B. maintaining on the digital data processing system (i) plural content facets, each corresponding to one or more required such tags, where at least one of the content facets corresponds to two or more required such tags, and (ii) one or more dialog facets, each associated with one or more content facets, and each including a dialog segment expandable using those associated content facets and (iii) an identification of content facets whose corresponding required tags are associated with digital assets,
C. driving a conversation with a user through a human machine interface based on facets identified as associated with digital assets and using dialog segments that are expanded with content facets associated with the dialog facets in which those segments are included, the chat bot expanding the dialog segments to include only content facets for which the corresponding required tags are identified as associated with assets in the content management system, while excluding those content facets not so identified,
D. transmitting to the user digital assets identified through the conversation.

12. A method of digital content generation comprising executing on a digital data processing system, the steps of:
A. for each of a plurality of digital assets, maintaining in a content management system executing on the digital data processing system (i) an identifier of the respective digital asset and (ii) one or more associated tags that characterize that asset,
B. maintaining in an ontology manager executing on the digital data processing system (i) plural content facets, each corresponding to one or more required tags of the content management system, and (ii) one or more dialog facets, each associated with one or more content facets, and each including a dialog segment expandable using those associated content facets, and (iii) an identification of content facets whose corresponding required tags are associated with digital assets in the content management system,
C. with a chat bot executing on the digital data processing system, driving a conversation with a user through a human machine interface based on facets identified as associated with assets in the content management system and using dialog segments that are expanded with content facets associated with the dialog facets in which those segments are included, the chat bot expanding the dialog segments to include only content facets for which the corresponding required tags are identified as associated with assets in the content management system, while excluding those content facets not so identified,
D. transmitting to the user digital assets identified through the conversation.

13. The method of claim 12, comprising executing on the digital data processing system the step of exchanging, between the content management system and the ontology manager, facets and/or tags in order to (i) establish correspondence between facets of the ontology manager and tags available for characterizing digital assets and/or potential digital assets in the content management system, (ii) identify facets that correspond to tags associated with digital assets in the content management system.

14. The method of claim 12, comprising executing on a digital data processing system the step of identifying, with the chat bot, tags corresponding with facets selected by the user during the conversation.

15. The method of claim 14, comprising executing on a digital data processing system the step of retrieving, with the content management system, digital assets associated with the tags identified by the chat bot.

16. The method of claim 15, comprising executing on a digital data processing system the step of transmitting to the user the digital assets associated with the tags identified by the chat bot.

17. The method of claim 12, comprising executing on a digital data processing system the steps of
associating sequence numbers with the plural facets, and
driving the conversation as an additional function of those sequence numbers.

18. The method of claim 12, comprising executing on a digital data processing system the steps of
assigning one or more lexical indicators to each of one or more facets in the ontology manager, each lexical indicator representing a common language, dialect or other lexicon,
driving the conversation as an additional function of the lexical indicator associated with the facets.

19. The method of claim 18, comprising executing on a digital data processing system the step of driving the conversation to exclude dialog segments associated with facets not associated with one or more designated lexical indicators.

20. The method of claim 12, comprising executing on a digital data processing system the step of driving the conversation with any of text, radio boxes, check boxes and other user interface widgets.

21. The method of claim 20, comprising executing on a digital data processing system the steps of
associating one or more facets with format indicators, and
selecting user interface widgets with which to drive the conversation as a function of those format indicators.

22. The method of claim 12, comprising executing on a digital data processing system the step of driving the conversation to exclude dialog segments associated with one or more content facets whose corresponding required tags are not associated with digital assets in the content management system.
